(19) United States
(12) Patent Application Publication
(10) Pub. No.: US 2009/0042608 A1
(43) Pub. Date: Feb. 12, 2009

(54) MOBILE TERMINAL AND METHOD OF CONNECTING EXTERNAL DEVICE TO MOBILE TERMINAL

(75) Inventors: Byoung Pyo Moon, Gyeonggi-do (KR); In Suk Kim, Gyeonggi-do (KR); Min Gwon Moon, Seoul (KR); Jae Young Choi, Seoul (KR); Hye Bong Lim, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 12/184,085

(22) Filed: Jul. 31, 2008

(30) Foreign Application Priority Data
Aug. 10, 2007 (KR) 10-2007-0080825

(51) Int. Cl. H04M 1/00

(52) U.S. Cl. 455/556.1; 455/557

(57) ABSTRACT

A mobile terminal and method of connecting an external device to a mobile terminal are provided that facilitates management of multimedia contents between the mobile terminal and the external device to which the mobile terminal is connected. The present invention includes an interface unit for connecting the mobile terminal to an external device and a control unit that controls the mobile terminal to be connected to the external device in a non-multimedia content management protocol mode if the external device does not support a multimedia content management protocol mode.

### CROSS-REFERENCE TO RELATED APPLICATIONS

This application claims the benefit of the Korean Patent Application No. 10-2007-0080825, filed on Aug. 10, 2007, which is hereby incorporated by reference as if fully set forth herein.

### FIELD OF THE INVENTION

The present invention is directed to a mobile terminal and, specifically, to a mobile terminal and method of connecting an external device to a mobile terminal. Although the present invention is suitable for a wide scope of applications, it is particularly suitable for playing back multimedia contents, such as audio files and moving picture files, with enhanced user convenience.

### DESCRIPTION OF THE RELATED ART

A mobile terminal is a device that may be configured to perform various functions. Examples of such functions include data and voice communications, capturing images and video via a camera, recording audio, playing music files via a speaker system, and displaying images and video on a display. Some terminals include additional functionality that supports game playing, while other terminals are configured as multimedia players. More recently, mobile terminals have been configured to receive broadcast and multicast signals that permit viewing of content such as videos and television programs.

Efforts are ongoing to support and increase the functionality of mobile terminals. Such efforts include software and hardware improvements, as well as changes and improvements in the structural components that form the mobile terminal.

It is necessary to download multimedia contents from an external device and store the downloaded multimedia contents in a mobile terminal in order to play back the multimedia contents. The mobile terminal is able to download multimedia contents by directly accessing an external multimedia contents server via a mobile communication network or Internet.

The mobile terminal is also able to download multimedia contents from an external device via a connection to the external device, such as by using a general personal computer (PC). The mobile terminal and the external device may be connected to each other via various connection modes.

However, a user not knowledgeable in using the terminal may not recognize that at least one of the mobile terminal and the external device is out of order if a mobile terminal and external device that are physically connected fail to recognize each other due to differing connection modes.

### SUMMARY OF THE INVENTION

In one aspect of the present invention, a mobile terminal for playing back multimedia contents is provided. The mobile terminal includes an interface unit for connecting the mobile terminal to an external device and a control unit configured to connect the mobile terminal to the external device in a non-multimedia content management protocol mode if the external device does not support a multimedia content management protocol mode when the mobile terminal is connected to the external device.

It is contemplated that the multimedia content management protocol mode is an MTP (media transfer protocol) mode. It is further contemplated that the non-multimedia content management protocol mode is a mass storage mode or a data service mode.

It is contemplated that the mass storage mode is a UMS (USB mass storage) mode. It is further contemplated that the data service mode is a PC sync mode.

It is contemplated that the control unit controls the external device to be connected in the mass storage mode when the mobile terminal supports loading an external memory and the control unit controls the external device to be connected in the data service mode when the mobile terminal does not support loading the external memory. It is further contemplated that the control unit controls the external device to be connected in the non-multimedia content management protocol mode automatically.

It is contemplated that the mobile terminal includes a display unit and the control unit controls the display unit to display a message indicating that an attempt to connect the mobile terminal to the external device in the multimedia content management protocol mode has failed. It is further contemplated that the mobile terminal includes a display unit and the control unit controls the display unit to display a message indicating the non-multimedia content management protocol mode if the mobile terminal and the external device are successfully connected in the non-multimedia content management protocol mode. Preferably, the interface unit further includes a USB (universal serial bus) connector and the mobile terminal is connected to the external device via the USB connector.

In another aspect of the present invention, a method of connecting an external device to a mobile terminal is provided. The method includes connecting an interface unit of the mobile terminal to the external device and connecting the external device in a non-multimedia content management protocol mode if the external device does not support a multimedia content management protocol mode.

It is contemplated that the multimedia content management protocol mode is an MTP (media transfer protocol) mode. It is further contemplated that the non-multimedia content management protocol mode is a mass storage mode or a data service mode.

It is contemplated that the mass storage mode is a UMS (USB mass storage) mode. It is further contemplated that the data service mode is a PC sync mode.

It is contemplated that the method includes connecting the external device in the mass storage mode when the mobile terminal supports loading an external memory and connecting the external device in the data service mode when the mobile terminal does not support loading the external memory. It is further contemplated that the method includes connecting the external device in the non-multimedia content management protocol mode automatically.

It is contemplated that the method includes displaying a message indicating that an attempt to connect the mobile terminal to the external device in the multimedia content management protocol mode has failed. It is further contemplated that the method includes displaying a message indicating the non-multimedia content management protocol mode if the mobile terminal and the external device are successfully connected in the non-multimedia content management protocol mode. Preferably, the external device is connected to the mobile terminal via a USB connector.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a block diagram of a mobile terminal in accordance with an embodiment of the present invention;

FIG. 2 is a perspective view of a front side of a mobile terminal according to an embodiment of the present invention;

FIG. 3 is a rear view of the mobile terminal shown in FIG. 2;

FIG. 4 is a block diagram of a CDMA wireless communication system operable with the mobile terminal of FIGS. 1 to 3;

FIG. 5 illustrates display screens to explain a process for setting a preferential connection mode with an external device in a mobile terminal according to the present invention.

FIG. 6 is a diagram illustrating a mobile terminal according to the present invention connected to an external device.

FIG. 7 illustrates a flowchart of a method of connecting an external device to a mobile terminal according to a first embodiment of the present invention.

FIG. 8 is a diagram illustrating display screens to explain successfully connecting a mobile terminal according to a first embodiment of the present invention to an external device in a preferential setting mode.

FIG. 9 is a diagram illustrating display screens to explain an unsuccessful connection of a mobile terminal according to a first embodiment of the present invention to an external device in a preferential setting mode.

FIG. 10 illustrates a flowchart of a method of connecting an external device to a mobile terminal according to a second embodiment of the present invention.

FIG. 11 is a diagram illustrates display screens to explain an unsuccessful connection of a mobile terminal according to a second embodiment of the present invention to an external device in a preferential setting mode.

### DETAILED DESCRIPTION OF THE PREFERRED EMBODIMENTS

Reference will be made in detail to the preferred embodiments of the present invention, examples of which are illustrated in the accompanying drawings. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or like parts.

The suffixes ‘module’, ‘unit’ and ‘part’ are given in the following description for elements in order to facilitate this disclosure only. Therefore, significant meanings or roles are not implied for the suffixes and it is understood that the terms ‘module’, ‘unit’ and ‘part’ can be used interchangeably.

The term ‘multimedia contents’ refers to various information including a medium constructed with audio, characters, figures, moving pictures or a combination thereof.

The term ‘synchronization’ refers to content and/or time relation of multimedia content being maintained between a mobile terminal connected to an external device in order to enable automatically sharing the multimedia content previously classified in the external device by a user with the mobile terminal.

The term ‘multimedia content management protocol mode’ refers to a connection mode enabling mutual synchronization when a mobile terminal is connected to an external device. For example, the ‘multimedia content measurement protocol’ may be the MTP (media transfer protocol) mode proposed by Microsoft Corporation.

The term ‘non-multimedia content management protocol’ refers to every connection mode except the ‘multimedia content management protocol mode’ that enables connecting a mobile terminal to an external device. The term ‘non-multimedia content management protocol mode’ includes a mass storage mode and a data service mode. For example, the mass storage mode may be a UMS (USB (universal serial bus) mass storage) mode and the data service mode may be PC sync.

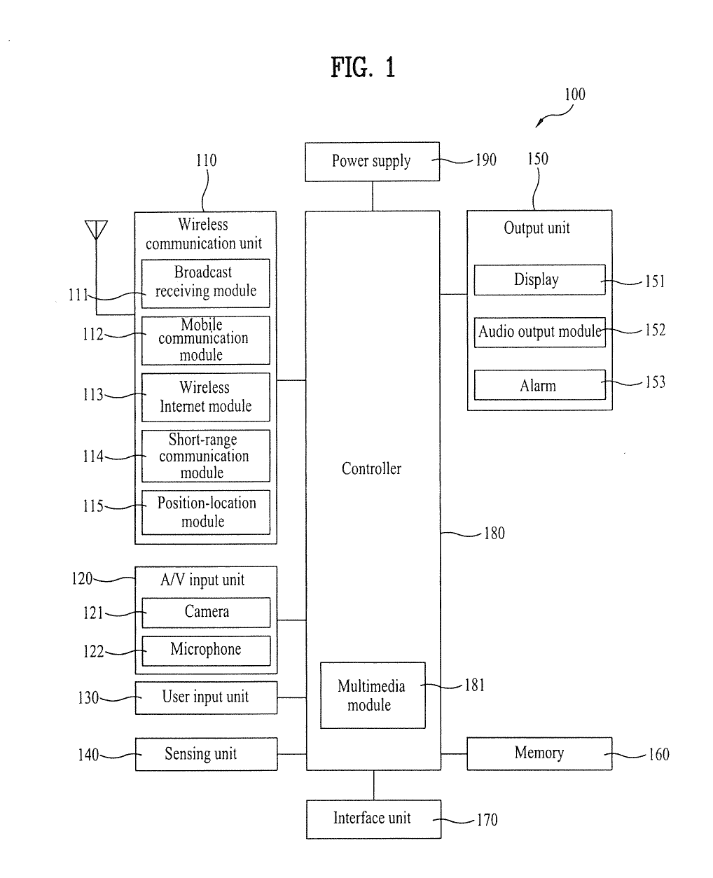

FIG. 1 is a block diagram of mobile terminal 100 in accordance with an embodiment of the present invention. The mobile terminal 100 may be implemented using a variety of different types of terminals. Examples of such terminals include mobile phones, user equipment, smart phones, computers, digital broadcast terminals, personal digital assistants, portable multimedia players (PMP) and navigators.

By way of non-limiting example only, further description will be with regard to a mobile terminal 100. However, such teachings apply equally to other types of terminals. FIG. 1 shows the mobile terminal 100 having various components, but it is understood that implementing all of the illustrated components is not a requirement. Greater or fewer components may alternatively be implemented.

FIG. 1 shows a wireless communication unit 110 configured with several commonly implemented components. For example, the wireless communication unit 110 typically includes one or more components that permit wireless communication between the mobile terminal 100 and a wireless communication system or network within which the mobile terminal is located.

The broadcast receiving module 111 receives a broadcast signal and/or broadcast associated information from an external broadcast managing entity via a broadcast channel. The broadcast channel may include a satellite channel or a terrestrial channel. The broadcast managing entity refers generally to a system that transmits a broadcast signal and/or broadcast associated information. Examples of broadcast associated information include information associated with a broadcast channel, a broadcast program, and a broadcast service provider. For example, the broadcast associated information may include an electronic program guide (EPG) of digital multimedia broadcasting (DMB) and electronic service guide (ESG) of digital video broadcast-handheld (DVB-H).

The broadcast signal may be implemented, for example, as a TV broadcast signal, a radio broadcast signal, or a data broadcast signal. The broadcast signal may further include a broadcast signal combined with a TV or radio broadcast signal.

The broadcast receiving module 111 may be configured to receive broadcast signals transmitted from various types of broadcast systems. By way of non-limiting examples, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving multicast signals is also possible. Data received by the broadcast receiving module 111 may be stored in a suitable device, such as the memory 160.

The mobile communication module 112 communicates wireless signals with one or more network entities, such as base station or Node-B. Such signals may represent, for example, audio, video, multimedia, control signaling, or data.

The wireless Internet module 113 supports Internet access for the mobile terminal 100. The wireless Internet module 113 may be internally or externally coupled to the mobile terminal 100.

The short-range communication module 114 facilitates relatively short-range communications. Suitable technologies for short-range communication may include, but are not limited to, radio frequency identification (RFID), infrared data association (IrDA), ultra-wideband (UWB), as well at the networking technologies commonly referred to as Bluetooth® and ZigBee®.

The position-location module 115 identifies or otherwise obtains the location of the mobile terminal 100. The position-location module 115 may be implemented using global positioning system (GPS) components that cooperate with associated satellites, network components, and combinations thereof.

The audio/video (A/V) input unit 120 is configured to provide audio or video signal input to the mobile terminal 100. As shown, the A/V input unit 120 includes a camera 121 and a microphone 122.

The camera 121 receives and processes image frames of still pictures or video.

The microphone 122 receives an external audio signal while the mobile terminal 100 is in a particular mode, such as phone call mode, recording mode and voice recognition. This audio signal is processed and converted into digital data. The mobile terminal 100, and specifically the A/V input unit 120, may include assorted noise removing algorithms to remove noise generated in the course of receiving the external audio signal. Data generated by the A/V input unit 120 may be stored in the memory 160, utilized by the output unit 150, or transmitted via one or more modules of the communication unit 110. If desired, two or more microphones and/or cameras may be used.

The user input unit 130 generates input data responsive to user manipulation of an associated input device or devices. Examples of such devices include a keypad, a dome switch, a touchpad such as static pressure/capacitance, a jog wheel and a jog switch. A specific example is one in which the user input unit 130 is configured as a touchpad in cooperation with a touch screen display, which will be described in more detail later.

The sensing unit 140 provides status measurements of various aspects of the mobile terminal 100. For example, the sensing unit 140 may detect an open/close status of the mobile terminal 100, the relative positioning of components such as a display and keypad, a change of position of the mobile terminal or a component of the mobile terminal, a presence or absence of user contact with the mobile terminal, orientation or acceleration/deceleration of the mobile terminal.

The mobile terminal 100 may be configured as a slide-type mobile terminal and the sensing unit 140 may sense whether a sliding portion of the mobile terminal is open or closed. The sensing unit 140 may also sense the presence or absence of power provided by the power supply 190, the presence or absence of a coupling or other connection between the interface unit 170 and an external device.

The interface unit 170 may be implemented to couple the mobile terminal 100 with external devices. Typical external devices include wired/wireless headphones, external chargers, power supplies, storage devices configured to store data such as audio, video, and pictures, earphones, and microphones. The interface unit 170 may be configured using a wired/wireless data port, audio input/output ports, video input/output ports, or a card socket for coupling to a memory card, subscriber identity module (SIM) card, user identity module (UIM) card, or a removable user identity module (RUIM) card.

The output unit 150 may include various components that support the output requirements of the mobile terminal 100. The display 151 may be implemented to visually display information associated with the mobile terminal 100. The display 151 may provide a user interface or graphical user interface that includes information associated with placing, conducting, and terminating a phone call if the mobile terminal 100 is operating in a phone call mode. As another example, the display 151 may additionally or alternatively display images that are associated with a video call mode or a photographing mode.

One particular implementation of the present invention includes the display 151 configured as a touch screen working in cooperation with an input device, such as a touchpad. This configuration permits the display 151 to function both as an output device and an input device.

The display 151 may be implemented using known display technologies including a liquid crystal display (LCD), a thin film transistor-liquid crystal display (TFT-LCD), an organic light-emitting diode display (OLED), a flexible display and a three-dimensional display. The mobile terminal 100 may include one or more displays 151. An example of a two-display embodiment is one in which one display 151 is configured as an internal display viewable when the terminal is in an opened position and a second display 151 configured as an external display viewable in both the open and closed positions.

FIG. 1 further shows the output unit 150 having an audio output module 152, which supports the audio output requirements of the mobile terminal 100. The audio output module 152 may be implemented using one or more speakers, buzzers, other audio producing devices, or combinations thereof.

The audio output module 152 functions in various modes such as call-receiving mode, call-placing mode, recording mode, voice recognition mode and broadcast reception mode. The audio output module 152 outputs audio relating to a particular function or status, such as call received, message received, or errors.

The output unit 150 is further shown having an alarm 153, which may signal or otherwise identify the occurrence of a particular event associated with the mobile terminal 100. Typical events include call received, message received and user input received.

An example of a signal provided by the output unit 150 is a tactile sensation. For example, the alarm 153 may be configured to vibrate responsive to the mobile terminal 100 receiving a call or message. As another example, vibration may be provided by the alarm 153 responsive to receiving user input at the mobile terminal 100 in order to provide a tactile feedback mechanism. It is understood that the various signals provided by the components of output unit 150 may be separately performed, or performed using any combination of such components.

The memory 160 is generally used to store various types of data to support the processing, control, and storage requirements of the mobile terminal 100. Examples of such data include program instructions for applications operating in the mobile terminal 100, contact data, phonebook data, messages, pictures, and video.

The memory 160 shown in FIG. 1 may be implemented using any type or combination of suitable volatile and non-volatile memory or storage devices. Examples of memory types are random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk memory, card-type memory, and other similar memory or data storage devices.

The controller 180 typically controls the overall operations of the mobile terminal 100. For example, the controller 180 performs the control and processing associated with voice calls, data communications, instant message communication, video calls, camera operations and recording operations.

The controller 180 may include a multimedia module 181 that provides multimedia playback. The multimedia module 181 may be configured as part of the controller 180, or implemented as a separate component.

The power supply 190 provides power required by the various components for the mobile terminal 100. The power may be internal power, external power, or combinations thereof.

Various embodiments described herein may be implemented in various ways. For example, the embodiments may be implemented in a computer-readable medium using computer software, hardware, or some combination thereof.

For a hardware implementation, the embodiments described may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. The controller 180 may also implement such embodiments.

For a software implementation, the embodiments described herein may be implemented with separate software modules, such as procedures and functions, each of which perform one or more of the functions and operations described herein. The software codes can be implemented with a software application written in any suitable programming language and may be stored in memory, such as the memory 160, and executed by a controller or processor, such as the controller 180.

The mobile terminal 100 may be implemented in a variety of different configurations. Examples of such configurations include folder-type, slide-type, bar-type, rotational-type, swing-type and combinations thereof. For clarity, further disclosure will primarily relate to a slide-type mobile terminal 100. However, such teachings apply equally to other types of mobile terminals 100.

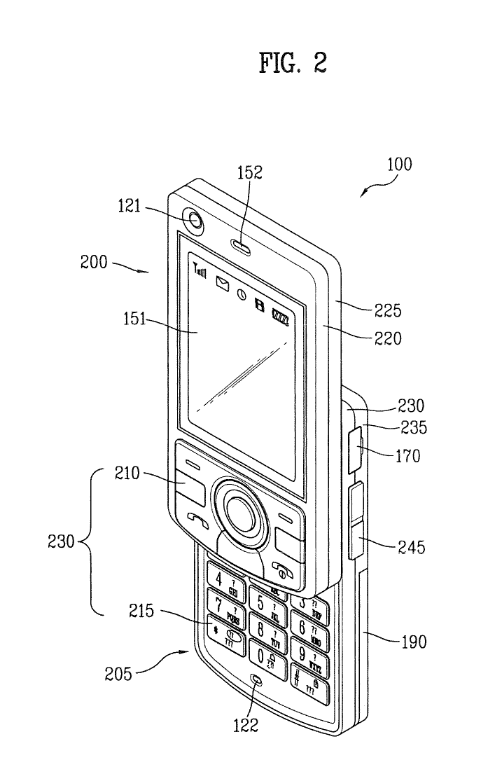

FIG. 2 is a perspective view of a front side of a mobile terminal 100 according to an embodiment of the present invention. In FIG. 2, the mobile terminal 100 is shown having a first body 200 configured to slidably cooperate with a second body 205.

The user input unit 130 (described in FIG. 1) is implemented using function keys 210 and a keypad 215. The function keys 210 are located on the first body 200 and the keypad 215 is located on the second body 205. The keypad 215 includes various keys, such as numbers, characters, and symbols to enable a user to place a call, prepare a text or multimedia message, and otherwise operate the mobile terminal 100.

The first body 200 slides relative to the second body 205 between open and closed positions. The first body 200 is positioned over the second body 205 in the closed position such that the keypad 215 is substantially or completely obscured by the first body. User access to the keypad 215, the display 151 and the function keys 210 is facilitated in the open position. The function keys 210 are conveniently configured for a user to enter commands, such as start, stop and scroll.

The mobile terminal 100 is operable in either a standby mode or an active call mode. The mobile terminal 100 is able to receive a call or message and to receive and respond to network control signaling in the standby mode.

The mobile terminal 100 typically operates in the standby mode in the closed position and in the active mode in the open position. This mode configuration may be changed as required or desired.

The first body 200 is shown formed of a first case 220 and a second case 225. The second body 205 is shown formed of a first case 230 and a second case 235. The front case 220 and second case 225 of the first body 200 and the first case 230 and second case 235 or the second body 205 are usually formed of a suitably rigid material, such as injection molded plastic, or formed using metallic material, such as stainless steel (STS) and titanium (Ti).

One or more intermediate cases may be provided between the first case 220 and second case 225 of the first body 200 or between the first case 230 and second case 235 of the second body 205. The first body 200 and second body 205 are typically sized to receive electronic components necessary to support operation of the mobile terminal 100.

The first body 200 is shown having a camera 121 and audio output module 152, which is configured as a speaker, positioned relative to the display 151. The camera 121 may be constructed such that it can be selectively positioned relative to first body 200, such as by rotation or swiveling.

The function keys 210 are positioned adjacent to a lower side of the display 151, which is shown implemented as an LCD or OLED. The display 151 may also be configured as a touch screen having an underlying touchpad which generates signals responsive to user contact with the touch screen, such as with a finger or stylus.

The second body 205 is shown having a microphone 122 positioned adjacent to the keypad 215 and having side keys 245, which are one type of user input unit, positioned along the side of second body. Preferably, the side keys 245 are configured as hot keys, such that the side keys are associated with a particular function of the mobile terminal 100.

An interface unit 170 is shown positioned adjacent to the side keys 245. A power supply 190 in a form of a battery is shown located on a lower portion of the second body 205.

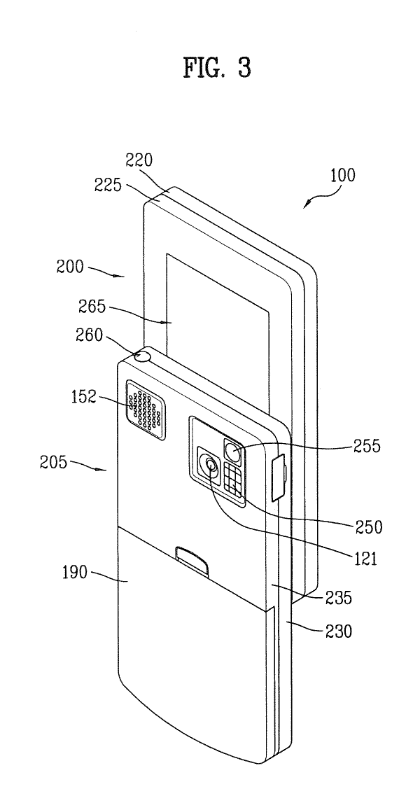

FIG. 3 is a rear view of the mobile terminal shown in FIG. 2. FIG. 3 shows the second body 205 having a camera 121 with an associated flash 250 and mirror 255. The flash 250 operates in conjunction with the camera 121. The mirror 255 is useful for assisting a user to position the camera 121 in a self-portrait mode.

The camera 121 of the second body 205 illustrated in FIG. 3 faces a direction opposite to a direction faced by the camera 121 of the first body 200 illustrated in FIG. 2. Each of the cameras 121 of the first body 200 and second body 205 may have the same or different capabilities.

The camera 121 of the first body 200 in one embodiment operates with a relatively lower resolution than the camera 121 of the second body 205. Such an arrangement works well during a videoconference, for example, in which reverse link bandwidth capabilities may be limited. The relatively higher resolution of the camera 121 of the second body 205 is useful for obtaining higher quality pictures for later use or for communicating with other parties.

The second body 205 illustrated in FIG. 3 also includes an audio output module 152 located on an upper side of the second body and configured as a speaker. The audio output modules 152 of the first body 200 and second body 205 may cooperate to provide stereo output. Moreover, either or both of these audio output modules 152 may be configured to operate as a speakerphone.

A broadcast signal receiving antenna 260 is shown located at an upper end of the second body 205 in FIG. 3. The antenna 260 functions in cooperation with the broadcast receiving module 111 illustrated in FIG. 1. The antenna 260 may be fixed or retractable into the second body 205.

The rear side of the first body 200 includes a slide module 265. The slide module 265 slidably couples with a corresponding slide module located on the front side of the second body 205.

It is understood that the arrangement of the various components of the first body 200 and second body 205 illustrated in FIGS. 2 and 3 may be modified as required or desired. For example, some or all of the components of one body may alternatively be implemented on the other body. Further, the location and relative positioning of the components are not critical and, therefore, the components may be positioned at locations that differ from those shown in FIGS. 2 and 3.

The mobile terminal 100 of FIGS. 1-3 may be configured to operate within a communication system which transmits data via frames or packets, including both wireless and wired communication systems and satellite-based communication systems. Such communication systems utilize different air interfaces and/or physical layers.

Examples of air interfaces utilized by the communication systems include frequency division multiple access (FDMA), time division multiple access (TDMA), code division multiple access (CDMA), the universal mobile telecommunications system (UMTS), the long-term evolution (LTE) of the UMTS, and the global system for mobile communications (GSM). By way of non-limiting example only, further description will relate to a CDMA communication system, but such teachings apply equally to other system types.

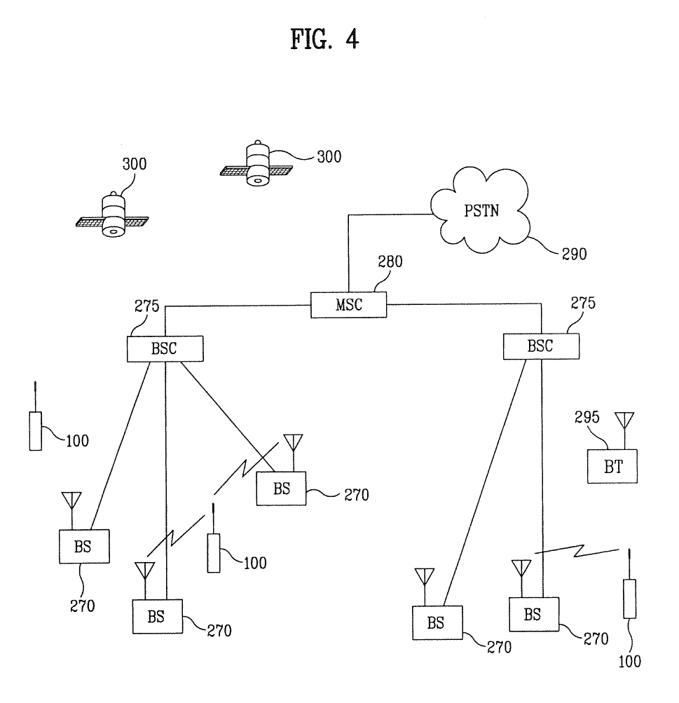

Referring to FIG. 4, a CDMA wireless communication system is shown having a plurality of mobile terminals 100, a plurality of base stations (BS) 270, a plurality of base station controllers (BSC) 275, and a mobile switching center (MSC) 280.

The MSC 280 is configured to interface with a conventional public switch telephone network (PSTN) 290. The MSC 280 is also configured to interface with the BSCs 275.

The BSCs 275 are coupled to the base stations 270 via backhaul lines. The backhaul lines may be configured in accordance with any of several known interfaces including E1/T1, ATM, IP, PPP, Frame Relay, HDSL, ADSL, or xDSL. It is to be understood that the system may include more than two BSCs 275.

Each BS 270 may include one or more sectors, each sector having an omni-directional antenna or an antenna pointed in a particular direction radially away from the base station. Alternatively, each sector may include two antennas for diversity reception. Each BS 270 may be configured to support a plurality of frequency assignments each having a particular spectrum, such as 1.25 MHz or 5 MHz.

The intersection of a sector and frequency assignment may be referred to as a CDMA channel. The BSs 270 may also be referred to as base station transceiver subsystems (BTSs).

The term “base station” may be used to refer collectively to a BSC 275 and one or more BSs 270. The BSs 270 may also be denoted as “cell sites.” Alternatively, individual sectors of a given BS 270 may be referred to as “cell sites.”

A terrestrial digital multimedia broadcasting (DMB) transmitter (BT) 295 is shown broadcasting to the mobile terminals 100 operating within the system. The broadcast receiving module 111 illustrated in FIG. 1 may be configured to receive broadcast signals transmitted by the BT 295. Similar arrangements may be implemented for other types of broadcast and multicast signaling as discussed above.

FIG. 4 further depicts several global positioning system (GPS) satellites 300 that facilitate locating the position of some or all of the mobile terminals 100. Two satellites 300 are depicted, but it is understood that useful positioning information may be obtained with greater or fewer satellites.

The position-location module 115 illustrated in FIG. 1 may be configured to cooperate with the satellites 300 to obtain desired position information. It is to be appreciated that other types of position detection technology may alternatively be implemented, such as location technology that may be used in addition to or instead of GPS location technology. If desired, some or all of the GPS satellites 300 may alternatively or additionally be configured to provide satellite DMB transmissions.

During typical operation of the wireless communication system, the BSs 270 receive sets of reverse-link signals from various mobile terminals 100. The mobile terminals 100 perform calls, messaging, and other communications.

Each reverse-link signal received by a given BS 270 is processed within that BS. The resulting data is forwarded to an associated BSC 275.

The BSC 275 provides call resource allocation and mobility management functionality including soft handoffs between the BSs 270. The BSCs 275 also route the received data to the MSC 280, which provides additional routing services for interfacing with the PSTN 290.

Similarly, the PSTN 290 interfaces with the MSC 280, which interfaces with the BSCs 275. The BSCs 275 control the BSs 270 to transmit sets of forward-link signals to the mobile terminals 100.

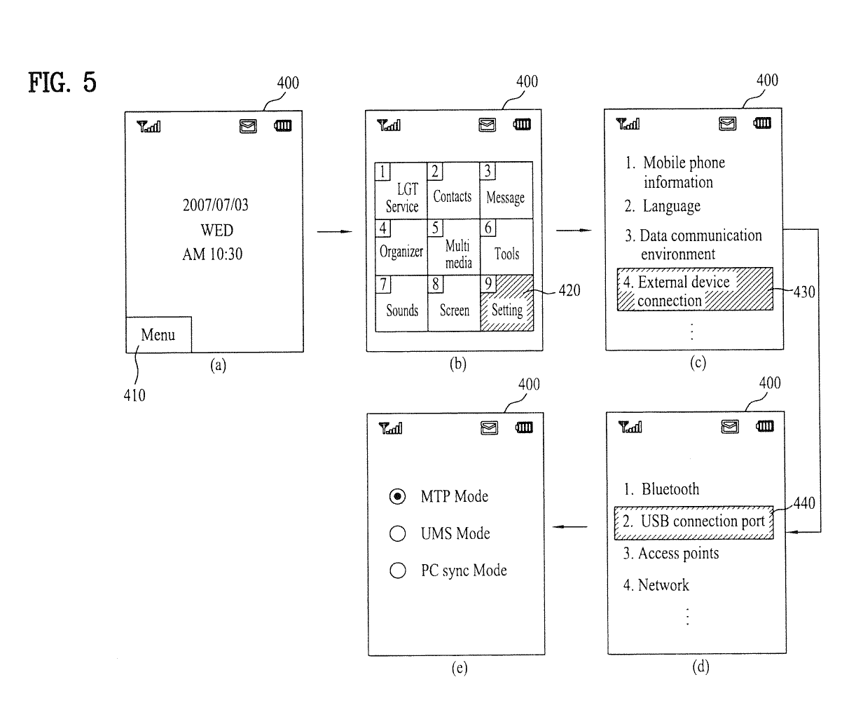

Embodiments of a controlling method implemented in the mobile terminal 100 are explained with reference to FIGS. 5-11. It is to be understood that the following embodiments can be used individually or in combination.

It is assumed in the following description that the mobile terminal 100 is connected to an external device via a USB connection using a USB port of the interface unit 170. Alternatively, the mobile terminal 100 and the external device can be connected via another connection as well as the USB connection using the USB port. It is also assumed in the following description that the multimedia content management protocol mode is MTP mode, the mass storage mode is UMS mode and the data service mode is PC sync mode.

A process for setting a connection mode, hereinafter referred to a ‘preferential connection mode’, for connecting a mobile terminal 100 to an external device is explained with reference to FIG. 5. FIG. 5 is a diagram illustrating display screens to explain a process for setting a preferential connection mode with an external device in a mobile terminal 100 according to the present invention.

FIG. 5(a) illustrates a standby image displayed on a display screen 400 of the mobile terminal 100. Various menu icons within the mobile terminal 100 are displayed if a ‘Menu’ icon 410 is selected from the standby image, as illustrated in FIG. 5(b). The selection of the ‘Menu’ icon 410 can be performed via a corresponding key manipulation such as a soft key (not shown) of the user input unit 130. The selection of the ‘Menu’ icon 410 can be performed by directly selecting the ‘Menu’ icon 410 from the display screen 400 if the display module 151 operates as a touch screen.

Methods for selecting the ‘Menu’ icon 410 are apparent to those skilled in the art. Therefore, details of the selection are omitted in the following description for clarity of the disclosure.

Subsequently, icons for submenus of the ‘Setting’ menu are displayed on the display screen 400, as illustrated in FIG. 5(c), if a ‘Setting’ menu icon 420 is selected from the various menu icons displayed in FIG. 5(b).

Subsequently, submenus of the ‘External device connection’ menu are displayed on the display screen 400, as illustrated in FIG. 5(c), if the ‘External device connection’ menu icon 430 is selected from the submenu icons displayed in FIG. 5(c).

Subsequently, preferential connection modes for connecting the mobile terminal 100 to the external device via a USB connection, as illustrated in FIG. 5(e), are displayed on the display screen 400 if the ‘USB connection mode’ menu icon 440 is selected from the submenu icons displayed in FIG. 5(d). The following description assumes that the preferential connection mode is set to the MTP mode, as illustrated in FIG. 5(e). Setting the ‘preferential connection mode setting’ can be omitted if the terminal manufacturer sets a default preferential connection mode for a prescribed connection mode.

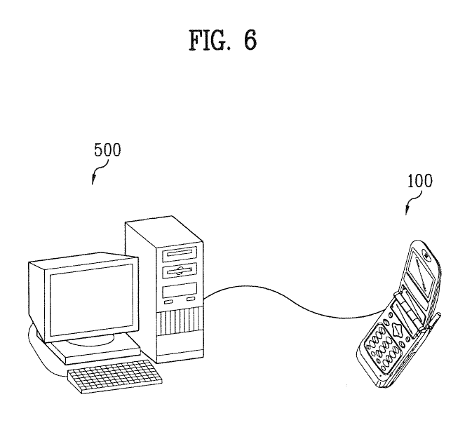

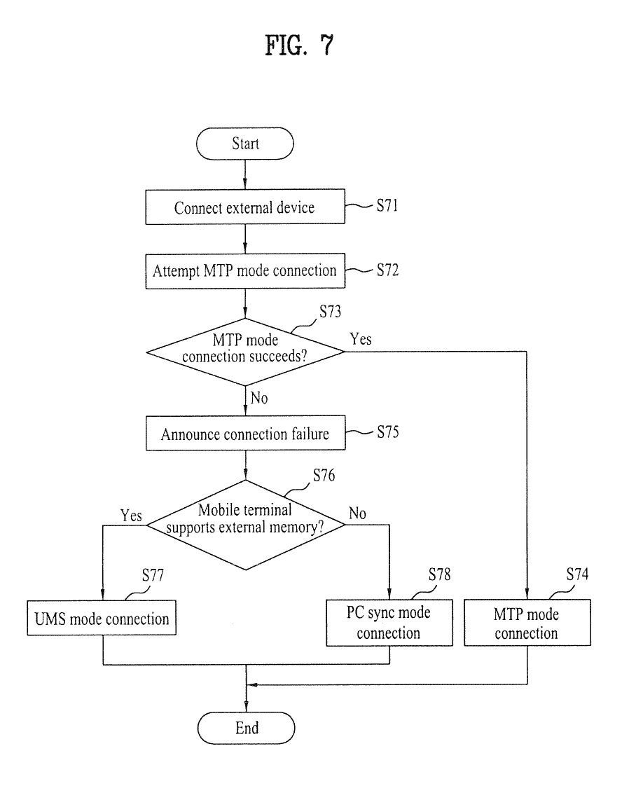

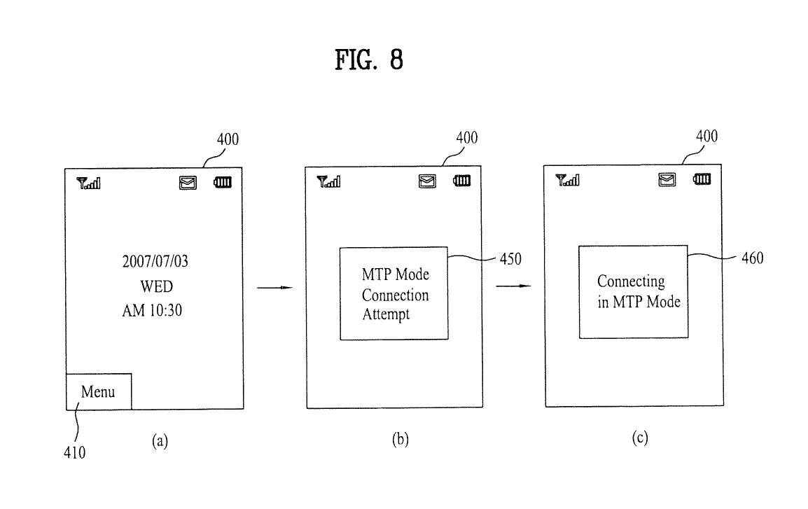

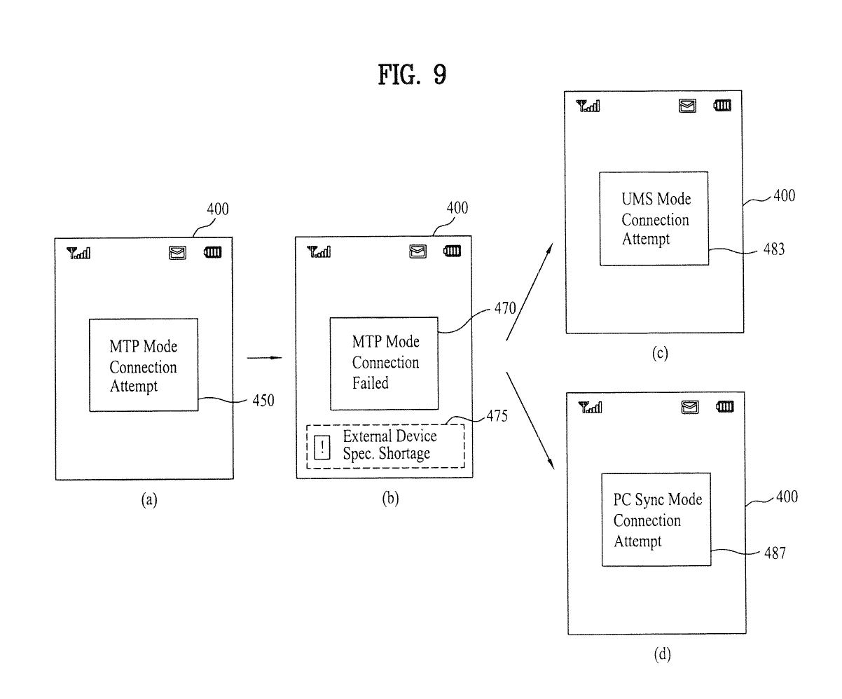

A method for connecting an external device to a mobile terminal 100 according to a first embodiment of the present invention is explained with reference to FIGS. 6 to 9. FIG. 6 illustrates a mobile terminal 100 according to the present invention connected to an external device 500. FIG. 7 illustrates a flowchart for a method of connecting an external device 500 to a mobile terminal 100 according to a first embodiment of the present invention. FIG. 8 illustrates display screens to explain successfully connecting a mobile terminal 100 according to a first embodiment of the present invention to an external device 500 in a preferential setting mode. FIG. 9 illustrates display screens to explain unsuccessfully connecting a mobile terminal 100 according to a first embodiment of the present invention to an external device 500 in a preferential setting mode.

The mobile terminal 100 is connected to an external device 500, such as a personal computer, via a USB connection (S71), as illustrated in FIG. 6. A standby image of the mobile terminal 100, as illustrated in FIG. 8(a), is then switched to an image indicating that the mobile terminal is trying to connect to the external device 500 in a preferential connection mode (S72), such as MTP mode, as illustrated in FIG. 8(b).

A mark indicating that the mobile terminal 100 is connected to the external device 500 in the MTP mode is displayed on the display screen 400 (S74), as illustrated in FIG. 8(c), if the connection between the mobile terminal and the external device is successfully established (S73).

The connection attempt between the mobile terminal 100 and the external device 500 may fail due to defects of the mobile terminal and/or the external device. Frequently, the connection failure is due to the external device 500 not being equipped with an option for the MTP mode connection. This situation is explained on the assumption that the external device 500 is a personal computer loaded with an operating system by Microsoft Corporation.

The operating system should have a version of Window XP®, Window Vista® or higher in order for the personal computer 500 to properly connect to the mobile terminal 100 via the MTP connection. The personal computer 500 is unable to support the MTP mode connection if the operating system has a lower version, such as Window 2000®, Window 98®, Window 95® or Window ME®. A version of Window Media Player (WMP)® used for the personal computer 500 should be WMP 10 or higher if Window XP® is installed in the personal computer 500.

The personal computer 500 is unable to provide the MTP mode connection despite being physically connected to the mobile terminal 100 if the personal computer fails to meet these requirements. A user not knowledgeable at using the mobile terminal 100 may often misunderstand that the mobile terminal or the personal computer 500 has defects. A situation where the MTP mode connection with the mobile terminal 100 fails due to a shortage of software options in the personal computer 500 according to the first embodiment of the present invention is explained in detail with reference to FIG. 9.

Referring to FIG. 9(a), the mobile terminal 100 attempts to establish an MTP mode connection to the personal computer 500 (S71). An announcement 450 indicating that the mobile terminal 100 is trying to establish an MTP mode connection to the personal computer 500 is displayed on the display screen 400 (S72).

An announcement 470 indicating that the connection failed is displayed on the display screen 400 (S75), as illustrated in FIG. 9(b), if the MTP mode connection fails (S73). The connection failure announcement 470 and a reason 475 for the connection failure may be displayed together or separately.

The mobile terminal 100 attempts to connect to the personal computer 500 in a connection mode other than the MTP connection mode, such as non-multimedia content management protocol mode, if the MTP mode connection fails, as illustrated in FIGS. 9(c) and FIG. 9(d). For example, the UMS mode and PC sync mode are illustrated as the non-multimedia content management protocol mode in FIGS. 9(c) and 9(d). Specifically, an announcement 483, 487 is displayed on the display screen 400 indicating that a connection attempt via UMS or PC sync mode is in progress, as illustrated in FIG. 9(c) and FIG. 9(d).

The connection is attempted using the UMS mode (S77), as illustrated in FIG. 9(c), if the mobile terminal 100 supports having an external memory loaded. The connection is attempted using the PC sync mode (S78), as illustrated in FIG. 9(d), if the mobile terminal 100 does not support having an external memory loaded.

The connection is attempted again if the connection between the mobile terminal 100 and the personal computer 500 is not established in the selected mode. For example, the connection attempt is made using the PC sync mode if the connection attempt using the UMS made fails and the connection attempt is made using the UMS made if the connection attempt using the PC sync mode fails.

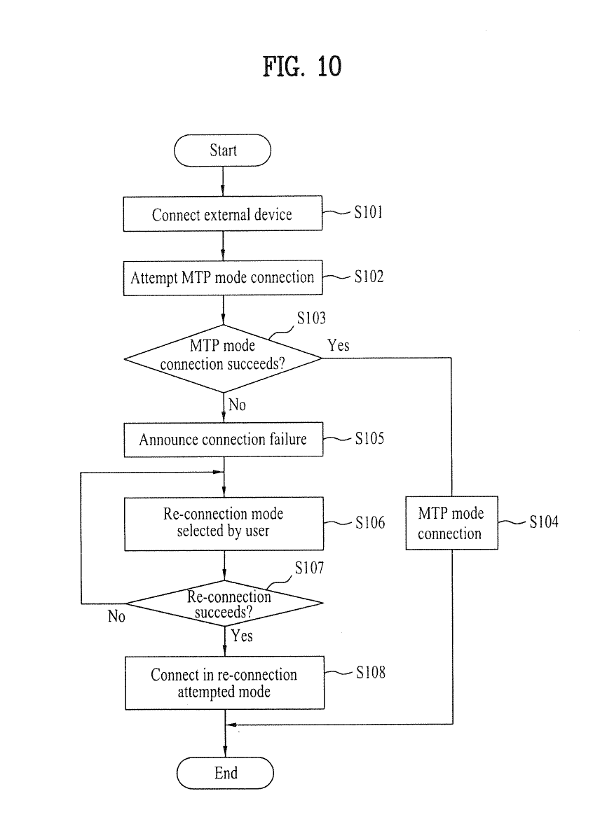

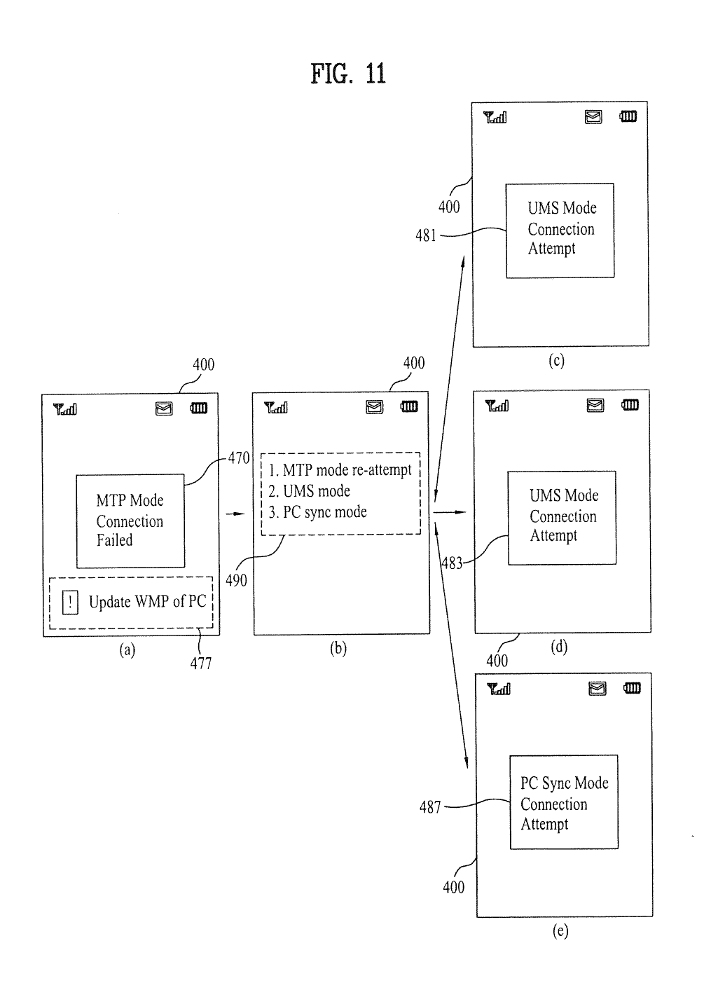

A method of connecting an external device 500 to a mobile terminal 100 according to a second embodiment of the present invention is explained with reference to FIG. 10 and FIG. 11. FIG. 10 illustrates a flowchart of a method for connecting an external device 500 to a mobile terminal 100 according to a second embodiment of the present invention and FIG. 11 illustrates display screens to explain a mobile terminal according to a second embodiment of the present invention failing to connect to an external device in a preferential setting mode.

The situation where an MTP connection between the mobile terminal 100 and the personal computer 500 is successfully established according to the second embodiment of the present invention is identical to the situation in the first embodiment of the present invention. Therefore, details will be omitted in the following description for clarity of the disclosure (S101, S102, S103, S104).

An announcement 470 indicating that the connection has failed is displayed on the display screen 400 (S105), as illustrated in FIG. 11(a), if the MTP mode connection between the mobile terminal 100 and the personal computer 500 fails. This is identical to the first embodiment of the present invention.

Unlike the first embodiment, an announcement 477 for a solution to the connection failure is displayed together with, or separate from, the connection failure announcement 470. As illustrated in FIG. 11(a), the announcement 477 indicates that a version of Window Media Player® installed in the personal computer might be updated. An Internet address enabling the personal computer 500 to update Window Media Player® is provided together with the update announcement 477.

Menus 490 enabling a user to select a connection mode for connection between the mobile terminal 100 and the personal computer 500 are subsequently displayed (S106) on the display screen 400, as illustrated in FIG. 11(b). The menus 490 displayed in FIG. 11(b) include ‘1. MTP mode re-attempt’, ‘2. UMS mode’, and ‘3. PC sync mode’. The mobile terminal 100 and the personal computer 500 are connected to each other using the re-attempted connection mode (S107, S108) if the re-attempted connection succeeds.

A connection between the mobile terminal 100 and the personal computer 500 is re-attempted using the MTP mode, as illustrated in FIG. 11(c) if ‘MTP mode re-attempt’ is selected. The display screen 400 returns to the image illustrated in FIG. 11(b) if the MTP mode connection re-attempt fails.

A connection between the mobile terminal 100 and the personal computer 500 is re-attempted using the UMS mode, as illustrated in FIG. 11(d), if the ‘UMS mode’ is selected. The display screen 400 returns to the image illustrated in FIG. 11(b) if the UMS mode connection fails.

A connection between the mobile terminal 100 and the personal computer 500 is re-attempted using the PC sync mode, as illustrated in FIG. 11(e), if the ‘PC sync mode’ is selected. The display screen 400 returns to the image illustrated in FIG. 11(b) if the PC sync mode connection fails.

The present invention provides several effects or advantages. First, the mobile terminal is able to re-attempt a connection using a different connection mode suitable for an external device when an attempted connection to an external device fails using a multimedia content management protocol mode due to shortage of software options. Second, a terminal user is notified when a connection between a mobile terminal and a personal computer fails due to shortage of software options. Therefore, the terminal user is informed that the mobile terminal and/or the external device has technical defects.

It will be apparent to those skilled in the art that various modifications and variations can be made in the present invention without departing from the spirit or scope of the inventions. For example, the methods of the invention can be implemented in a program recorded medium as computer-readable codes.

The computer-readable media include all types of recording devices in which data readable by a computer system are stored. The computer-readable media include ROM, RAM, CD-ROM, magnetic tapes, floppy discs, and optical data storage devices, and also include carrier-wave type implementations such as transmission via Internet. The computer can include the controller 180 of the terminal 100. Therefore, it is intended that the present invention covers the modifications and variations of this invention provided they come within the scope of the appended claims and their equivalents.

Depending on implementation, it is possible that the present invention can take the form of an entirely hardware embodiment, an entirely software embodiment or an embodiment containing both hardware and software elements. A software embodiment may include, but not be limited to, to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Other components may be coupled to the system. Input/output or I/O devices (including but not limited to keyboards, displays, pointing devices, etc.) can be coupled to the system either directly or through intervening I/O controllers. Network adapters (e.g., modem, cable modem, Ethernet cards) may also be coupled to the system to enable the data processing system to become coupled to other data processing systems or remote printers or storage devices through intervening private or public networks.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may be comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections of buried interconnections).

In any case, the chip is then integrated with other chips, discrete circuit elements, and/or other signal processing devices as part of either (a) an intermediate product, such as a motherboard, or (b) and end product. The end product can be any product that includes integrated circuit chips, ranging from toys and other low-end applications to advanced computer products having a display, a keyboard or other input device, and a central processor.

Therefore, it should be understood that the invention could be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

The foregoing embodiments and advantages are merely exemplary and are not to be construed as limiting the present invention. The present teaching can be readily applied to other types of apparatuses.

The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile terminal for playing back multimedia contents, the mobile terminal comprising:
an interface unit for connecting the mobile terminal to an external device; and
a control unit configured to connect the mobile terminal to the external device in a non-multimedia content management protocol mode if the external device does not support a multimedia content management protocol mode when the mobile terminal is connected to the external device.

2. The mobile terminal of claim 1, wherein the multimedia content management protocol mode comprises an MTP (media transfer protocol) mode.

3. The mobile terminal of claim 1, wherein the non-multimedia content management protocol mode comprises a mass storage mode or a data service mode.

4. The mobile terminal of claim 3, wherein the mass storage mode comprises a UMS (USB mass storage) mode.

5. The mobile terminal of claim 3, wherein the data service mode comprises a PC sync mode.

6. The mobile terminal of claim 3, wherein the control unit controls the external device to be connected in the mass storage mode when the mobile terminal supports loading an external memory and the control unit controls the external device to be connected in the data service mode when the mobile terminal does not support loading the external memory.

7. The mobile terminal of claim 1, wherein the control unit controls the external device to be connected in the non-multimedia content management protocol mode automatically.

8. The mobile terminal of claim 1, further comprising a display unit and wherein the control unit controls the display unit to display a message indicating that an attempt to connect the mobile terminal to the external device in the multimedia content management protocol mode has failed.

9. The mobile terminal of claim 1, further comprising a display unit and wherein the control unit controls the display unit to display a message indicating the non-multimedia content management protocol mode if the mobile terminal and the external device are successfully connected in the non-multimedia content management protocol mode.

10. The mobile terminal of claim 1, wherein the interface unit further comprises a USB (universal serial bus) connector and the mobile terminal is connected to the external device via the USB connector.

11. A method of connecting an external device to a mobile terminal the method comprising:
connecting an interface unit of the mobile terminal to the external device; and
connecting the external device in a non-multimedia content management protocol mode if the external device does not support a multimedia content management protocol mode.

12. The method of claim 11, wherein the multimedia content management protocol mode comprises an MTP (media transfer protocol) mode.

13. The method of claim 12, wherein the non-multimedia content management protocol mode comprises a mass storage mode or a data service mode.

14. The method of claim 13, wherein the mass storage mode comprises a UMS (USB mass storage) mode.

15. The method of claim 13, wherein the data service mode comprises a PC sync mode.

16. The method of claim 13, further comprising connecting the external device in the mass storage mode when the mobile terminal supports loading an external memory and connecting the external device in the data service mode when the mobile terminal does not support loading the external memory.

17. The method of claim 11, further comprising connecting the external device in the non-multimedia content management protocol mode automatically.

18. The method of claim 11, further comprising displaying a message indicating that an attempt to connect the mobile terminal to the external device in the multimedia content management protocol mode has failed.

19. The method of claim 11, further comprising displaying a message indicating the non-multimedia content management protocol mode if the mobile terminal and the external device are successfully connected in the non-multimedia content management protocol mode.

20. The method of claim 11, wherein the external device is connected to the mobile terminal via a USB connector.
